(19) United States
(12) Patent Application Publication
(10) Pub. No.: US 2017/0099085 A1
(43) Pub. Date: Apr. 6, 2017

(54) DISPLAY DEVICE WITH RADIO FREQUENCY IDENTIFICATION FUNCTIONS AND DATA PROCESSING METHOD THEREFOR

(71) Applicant: Sheng-Chieh Huang, Kaohsiung (TW)

(72) Inventors: Sheng-Chieh Huang, Kaohsiung (TW); Chieh-An Tsai, Kaohsiung (TW)

(21) Appl. No.: 15/273,697

(22) Filed: Sep. 22, 2016

(30) Foreign Application Priority Data
Oct. 1, 2015 (TW) 104132455

(51) Int. Cl. H04B 5/00; G06F 21/62; G09G 5/00

(52) U.S. Cl. CPC H04B 5/0062; G09G 5/003; G06F 21/6218; G09G 2358/00; G09G 2370/16

(57) ABSTRACT

A display device with radio frequency identification (RFID) functions includes a first antenna, a display unit and a radio frequency (RF) processing module. The RF processing module is RFID-based, is connected to the first antenna and the display unit, and processes user data and an induction current transmitted from the first antenna, transmits a display signal to the display unit to instruct the display unit to display, and can also transmit signals through the first antenna. Accordingly, users just need a RFID/NFC device, such as a smart phone, a tablet computer, a notebook computer or a desktop computer with NFC/RFID read/write features, to approach the RF processing module of the display device so as to facilitate instant data exchange and enhance operational convenience by means of instant display effect provided through the display unit.

### BACKGROUND OF THE INVENTION

1. Field of the Invention

The present invention relates to a display device and, more particularly, to a display device with radio frequency identification (RFID) functions and data processing therefore.

2. Description of the Related Art

Rapid development in technologies of wireless communication and semiconductor fabrication allows the concept of miniaturization to be feasibly implemented in a RFID/NFC (Near Field Communication) device for versatile use of the RFID/NFC device in a wide variety of applications, such as key chains, proximity cards, merchandise labels and the like, rendering convenience to people from all walks of life. However, early-stage RFID/NFC devices require batteries for operation, which cause operational inconvenience and additional cost arising from frequent replacement of battery.

To tackle the issue of battery replacement, a conventional battery-free RFID/NFC device thus brings into play. With reference to FIG. 13, the conventional battery-free RFID/NFC device includes a RFID/NFC antenna 90, a RFID/NFC control module 91, a display module 92, a power acquisition unit 93, and a RFID/NFC reader device 94. The RFID/NFC control module 91 is connected to the RFID/NFC antenna 90 and the display module 92. The RFID/NFC antenna 90 is connected to the RFID/NFC reader device 94. The RFID/NFC control module 91 has a memory unit embedded therein for data storage.

Despite the battery-free advantage of the conventional RFID device, the conventional RFID device can be connected through RFID in operation, such that users fail to be aware of operation status of the RFID device and has no interaction with the RFID/NFC device. The unavailability of status identification in operation of the conventional RFID/NFC device poses a difficulty in the conventional RFID/NFC device for bringing more convenience to users in their everyday life.

### SUMMARY OF THE INVENTION

An objective of the present invention is to provide a display device with radio frequency identification (RFID) functions and a data processing method for the same that allow user to exchange information with the display device, identify the display device in use, and acquire instant status of the display device through an RFID/NFC (Near Field Communication)-based device, such as a smart phone, a tablet computer, a notebook computer or a desktop computer with NFC/RFID read/write features, thereby increasing operational convenience of the display device for cross-field applications.

To achieve the foregoing objective, the display device with RFID functions is connected to a RFID/NFC device or an electronic device through RFID/NFC techniques, the data processing method is performed by the RFID/NFC device or the electronic device and includes steps of:

reading a user identification (UID) of the display device;

determining whether to read data of the display device;

reading the data in the display device, analyzing and processing the data to generate a piece of control information or a processed result according to a preset application to be applied to, when determining to read the data of the display device; and

displaying the UID, or the data corresponding to the UID, or a processed result, transmitting the piece of control information, the processed result and the received data to the display device, or transmitting the UID and the processed result to a remote server.

Given the foregoing data processing method, users can hold the RFID/NFC device to approach the display device with RFID/NFC functions and exchange data therewith through wireless communication. The RFID/NFC device accesses the UID of the display device and determines whether to read data depending on the application to be applied to. When determining to read the data, the RFID/NFC device reads and stores the data in its memory. According to the application, when analysis or processing of the data is required, the data is analyzed and processed to generate the control data or the processed result. When the data is based on NDEF format, the RFID/NFC device will automatically activate an application (if the data is a website address based on NDEF format, the RFID/NFC device automatically launches a browser) corresponding to the NDEF-based data. Furthermore, the RFID/NFC device or the electronic device can display the UID (or texts, symbol, graphics and the like corresponding to the UID) or the processed result (if the data is a NDEF website address, the RFID/NFC device is connected to the website address and displays the website). If required by the application, the RFID/NFC device can transmit the control information, or the processed result or the received data to the display device or transmit the UID or the processed result to a remote server depending on the requirement of the application. Accordingly, the RFID/NFC device or the electronic device can perform data communication with the server without the need of assigning new serial numbers to products, and the data processing method can deliver operational convenience to cross-field applications.

To achieve the foregoing objective, the display device with radio frequency identification (RFID) functions includes a display unit, a first antenna, and a radio frequency (RF) processing module.

The first antenna transceives signals and generates a first induction current by way of electromagnetic induction.

The RF processing module is connected to the first antenna and receives signals and the first induction current from the first antenna and has a first memory and a first UID unit.

The first memory stores data.

The first UID unit stores at least one user ID (UID) adapted for an external RFID/NFC device or other electronic device to identify the at least one UID, so that the RFID/NFC device or other electronic device can process and analyze the UID and the data received from the RF processing module to generate the control data or signal, and then transmit the control data, the UID or the data back to the RFID display device through the first antenna or to a remote server.

Given the foregoing display device with RFID functions, users can hold the RFID/NFC device to tape the display device so that the display device can communicate with the RFID/NFC device through the first antenna. The RFID/NFC display device stores the UID or data and exchanges information with a user's RFID/NFC device in operation and displays the information through the display unit by approaching the RFID/NFC device to the display device, such that the RFID/NFC device processes the UID and the data and then generates the control information/signal and displays the UID (or texts, symbol, graphics and the like corresponding to the UID) or the processed result. If required by the application, the RFID/NFC device can transmit the control information, or the processed result or the received data to the display device or transmit the UID or the processed result to a remote server. Additionally, users' awareness and attention of an operation status of the display device can be achieved through the light-emitting display units. Accordingly, the display device can deliver operational convenience to cross-field applications.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a first embodiment of a display device with RFID functions in accordance with the present invention;

FIG. 2 is a functional block diagram of a second embodiment of a display device with RFID functions in accordance with the present invention;

FIG. 3 is another functional block diagram of the display device with RFID functions in FIG. 2;

FIG. 4 is a functional block diagram of a third embodiment of a display device with RFID functions in accordance with the present invention;

FIG. 5 is a functional block diagram of a fourth embodiment of a display device with RFID functions in accordance with the present invention;

FIG. 6 is another functional block diagram of the display device with RFID functions in FIG. 5;

FIG. 7 is a functional block diagram of a fifth embodiment of a display device with RFID functions in accordance with the present invention;

FIG. 8 is a functional block diagram of a sixth embodiment of a display device with RFID functions in accordance with the present invention;

FIG. 9 is a functional block diagram of a seventh embodiment of a display device with RFID functions in accordance with the present invention;

FIG. 10 is a schematic diagram showing applications using a display device with RFID functions in accordance with the present invention;

FIG. 11 is a flow diagram of a data processing method in accordance with the present invention;

FIG. 12 is another flow diagram of the data processing method in FIG. 11; and

FIG. 13 is functional block diagram of a conventional battery-free RFID/NFC device.

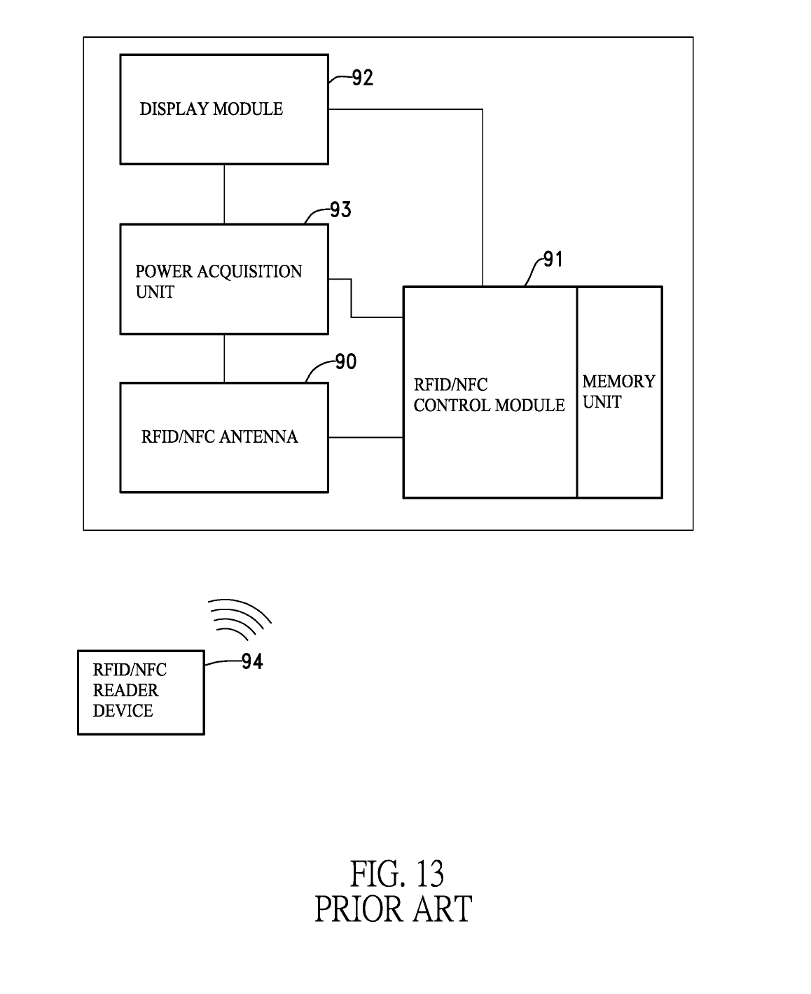

### DETAILED DESCRIPTION OF THE INVENTION

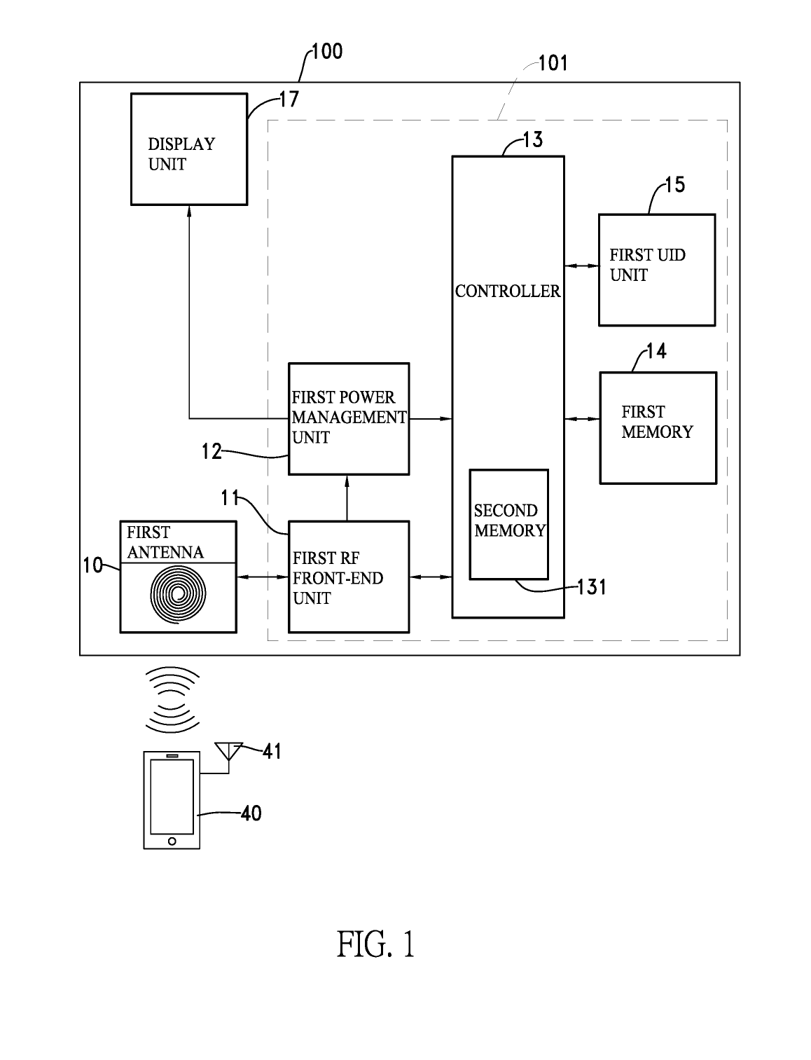

With reference to FIG. 1, a first embodiment of a display device with radio frequency identification (RFID) functions 100 in accordance with the present invention includes a first antenna 10, a radio frequency (RF) processing module 101 and a display unit 17. The display unit 17 is connected to a power output of the RF processing module 101 for the RF processing module 101 to turn on or off the display unit 17. The first antenna 10 serves to transceive signals and generate a first induction current by way of electromagnetic induction. The RF processing module 101 is connected to the first antenna 10.

The RF processing module 101 receives signals and the first induction current from the first antenna 10 and has a first memory 14 and a first UID unit 15. The first memory 14 stores data, such as data based on NDEF (NFC (Near-field communication) Data Exchange Format). The first user ID (UID) unit 15 stores at least one UID for an external RFID/NFC device 40 to identify the at least one UID. In the present embodiment, the RFID/NFC device 40 has an NFC antenna 41 transmitting and receiving signals to and from the first antenna 10 of the display device 100 according to a communication protocol, such that the RFID/NFC device 40 processes and analyzes the UID and data received from the display device 100 to generate control data/signal and then transmits the control data, the UID or the data back to the display device 100 through the first antenna 10 or to a remote server.

In the present embodiment, the RF processing module 101 includes a first RF front-end unit 11, a first power management unit 12 and a controller 13. The controller 13 has a second memory 131 to store a setting of the RF processing module 101 and a user's password, and is connected to the first RF front-end unit 11, the first power management unit 12 and the first memory 14 and the first UID unit 15. The first RF front-end unit 11 is connected to the first antenna 10 and the first power management unit 12. The first antenna 10 has an induction circuit and serves to transmit and receive signals and generate the first induction current by way of electromagnetic induction. The first antenna 10 then transmits the signals and the first induction current to the first RF front-end unit 11.

After converting the received signals, the first RF front-end unit 11 acquires the converted data and the first induction current and respectively transmits the converted data and the first induction current to the controller 13 and the first power management unit 12. In the present embodiment, the first power management unit 12 is connected to the display unit 17 that receives energy transmitted from the first power management unit 12. The first RF front-end unit 11 may be an RFID/NFC communication unit. After converting, rectifying and stabilizing voltage of the received first induction current, the first power management unit 12 respectively transmits signals to the controller 13 and the display unit 17, such that the display unit 17 is instructed to emit light, allowing users to be aware of operation status of the display device 100 through the display unit 17. In the present embodiment, the display unit 17 is a display with low power consumption, such as liquid crystal display (LCD), OLED (Organic light-emitting diode) display and the like, an electronic paper display or other displays having at least one LED (Light-emitting diode) component. The display function of the display unit 17 facilitates hearing-impaired persons to be aware of the operation status of the display device 100.

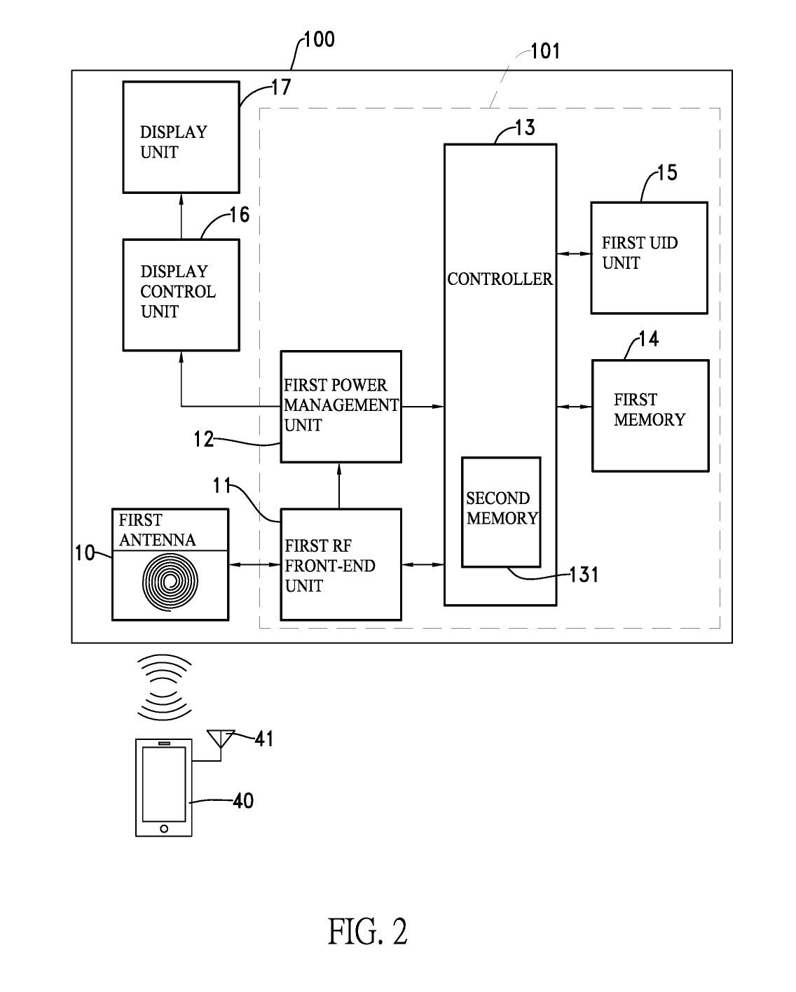

With reference to FIG. 2, a second embodiment of a display device with RFID functions 100 in accordance with the present invention differs from the first embodiment in that the first power management unit 12 is not directly connected to the display unit 17, the display device 100 further includes a display control unit 16, and the display control unit 16 is connected to the first power management unit 12 and the display unit 17 and receives the energy transmitted from the first power management unit 12. In the present embodiment, the display unit 17 is a control circuit formed by at least one passive component, such as resistor, capacitor, MOSFET, diode or the like, or a DC-DC converter, a display control processor, a microprocessor with display control functions, or an application processor, and the display unit 17 is a display with low power consumption, such as liquid crystal display (LCD), OLED (Organic light-emitting diode) display and the like, an electronic paper display or other displays having at least one LED (Light-emitting diode) component. The display function of the display unit 17 facilitates hearing-impaired persons to be aware of the operation status of the display device 100.

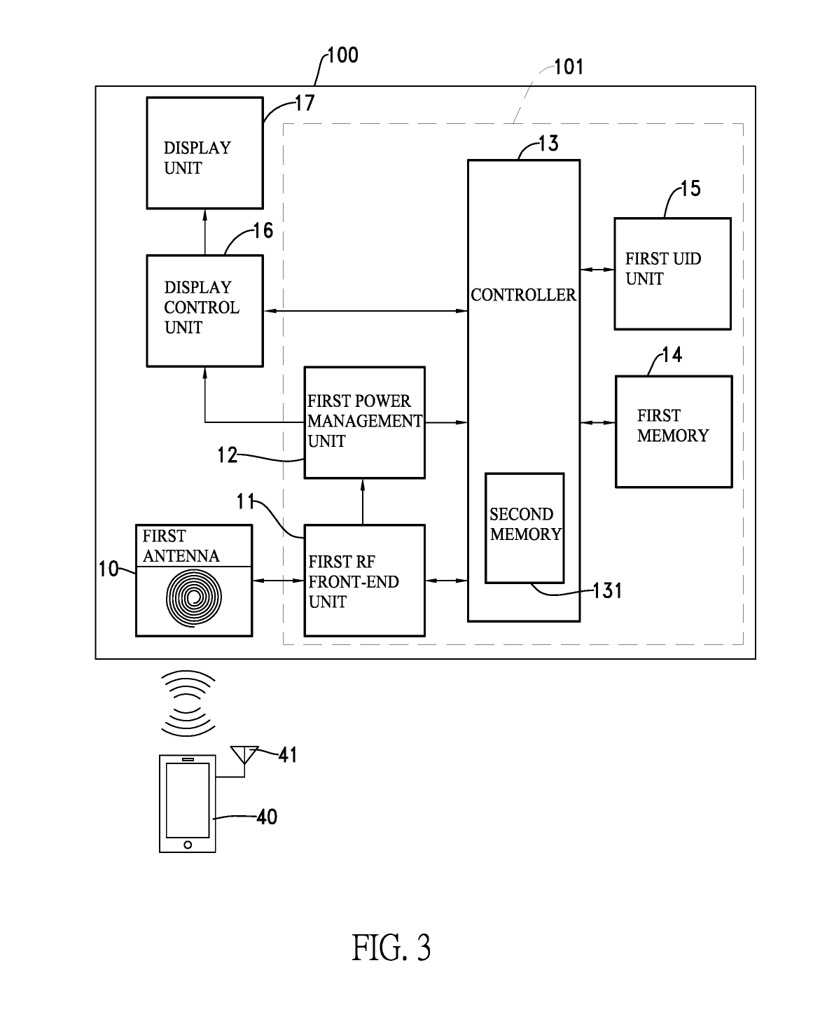

With reference to FIG. 3, the controller 13 is further connected to the display control unit 16. When the display device 100 receives the signals transmitted from the RFID/NFC device 40 through the first antenna 10, the display control unit 16 receives a display signal or a control signal transmitted from the controller 13 and transmits the display signal to the display unit 17 to instruct the display unit 17 to emit light and display data. The display control unit 16 can also store the data or parameters associated with a setting of the display unit 17 in the first memory 14 inside the RF processing module 101.

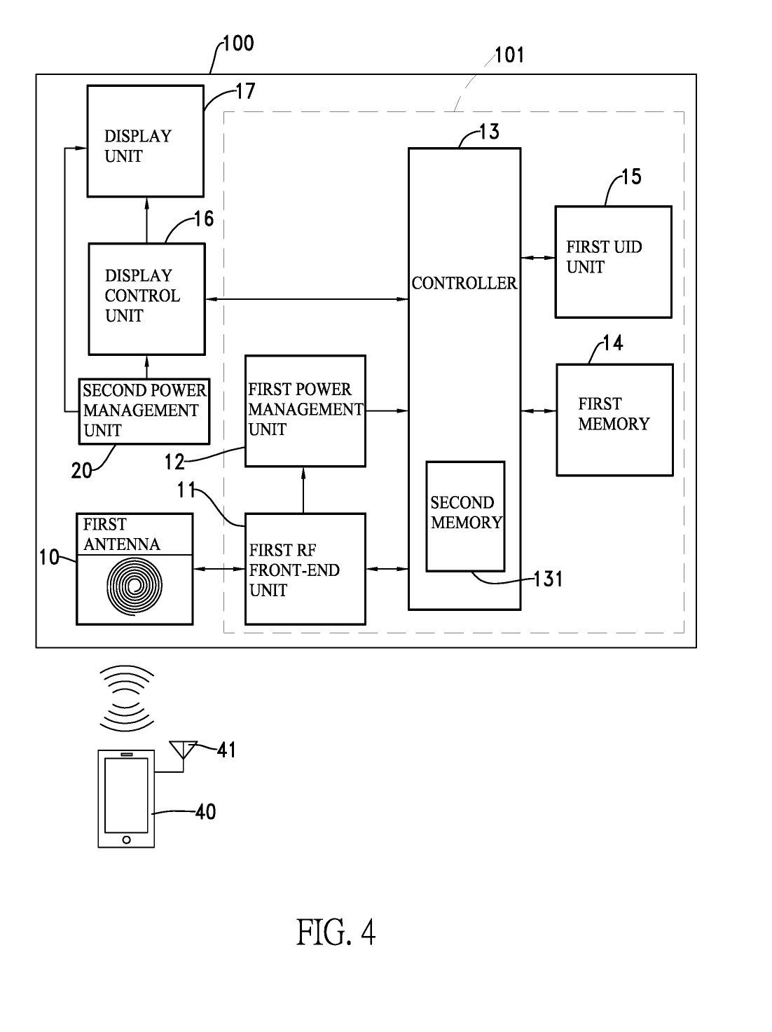

With reference to FIG. 4, a third embodiment of a display device with RFID functions in accordance with the present invention differs from the first embodiment in that the first power management unit 12 is not directly connected to the display unit 17 and the display device 100 further includes a display control unit 16 and a second power management unit 20, and the display control unit 16 is connected to the second power management unit 20, the display unit 17 and the controller 13. The display control unit 16 receives energy transmitted from the second first power management unit 12. The display unit 17 is connected to the second power management unit 20 to receive energy transmitted from the second power management unit 20. In the present embodiment, the second power management unit 20 is connected to an power output of the RF processing module 100 or a battery, and the display unit 17 is a control circuit formed by at least one passive component, such as resistor, capacitor, MOSFET, diode or the like, or a DC-DC converter, a display control processor, a microprocessor with display control functions, or an application processor, and the display unit 17 is a display with low power consumption, such as liquid crystal display (LCD), OLED (Organic light-emitting diode) display and the like, an electronic paper display or other displays having at least one LED (Light-emitting diode) component. The display function of the display unit 17 facilitates hearing-impaired persons to be aware of the operation status of the display device 100.

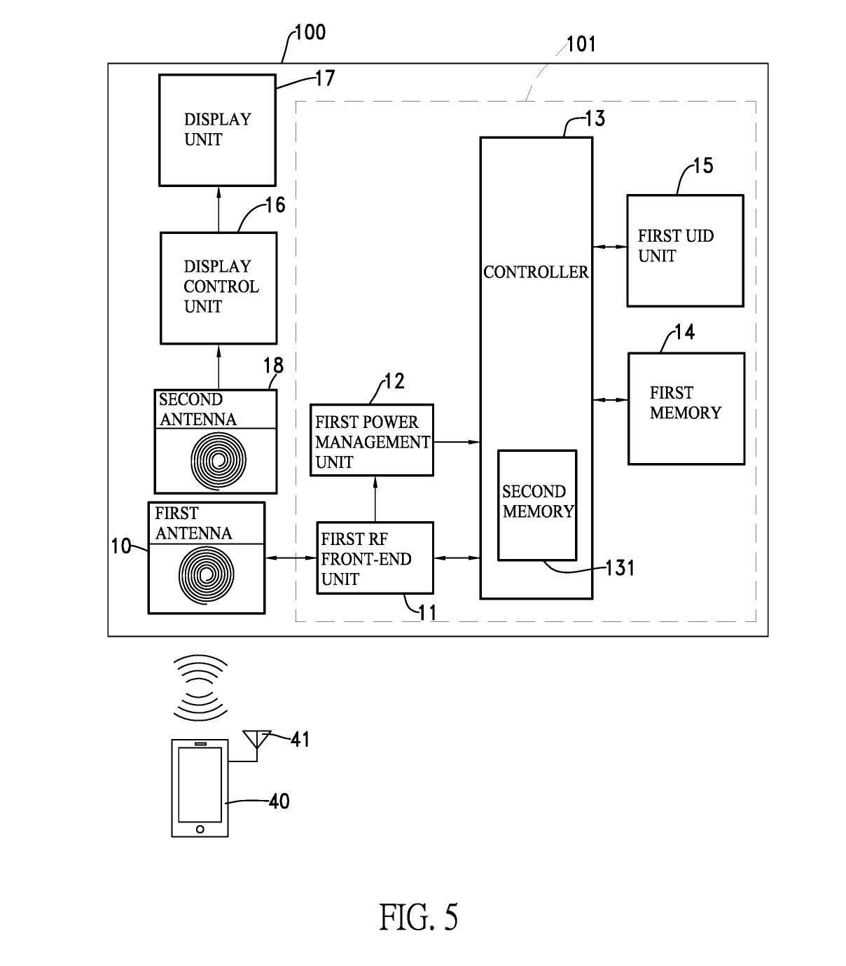

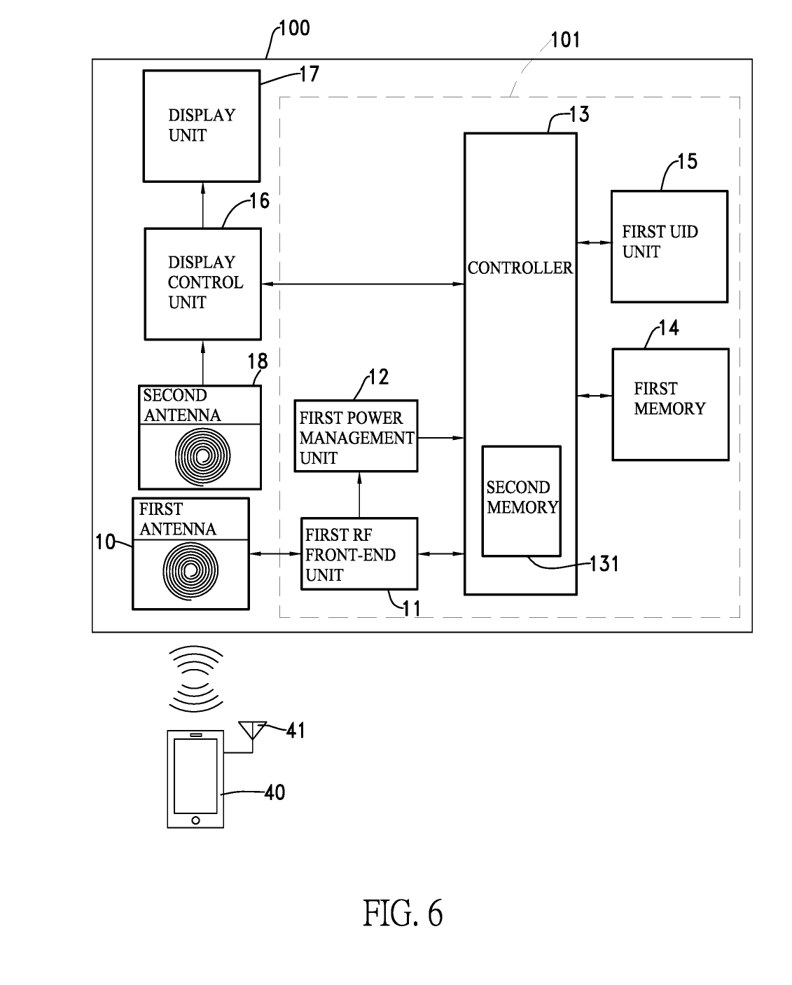

With reference to FIG. 5, a fourth embodiment of a display device with RFID functions 100 in accordance with the present invention differs from the first embodiment in that the display device 100 further includes a display control unit 16 and a second antenna 18, the first power management unit 12 is not directly connected to the display unit 17, the display control unit 16 is connected to the second antenna 18 and the display unit 17. In the present embodiment, the display unit 17 is a control circuit formed by at least one passive component, such as resistor, capacitor, MOSFET, diode or the like, or a DC-DC converter, a display control processor, a microprocessor with display control functions, or an application processor, and the second antenna 18 generates a second induction current, which is used to enable the display unit 17 to emit light and display data directly through the display control unit 16. With reference to FIG. 6, the controller 13 is further connected to the display control unit 16. The display control unit 16 receives the display signal or the control signal transmitted from the controller 13 and transmits the display signal to the display unit 17 to instruct the display unit 17 to emit light and display data directly through the display control unit 16. Alternatively, the display control unit 16 can store the data or parameters associated with a setting of the display unit 17 in the first memory 14 inside the RF processing module 101.

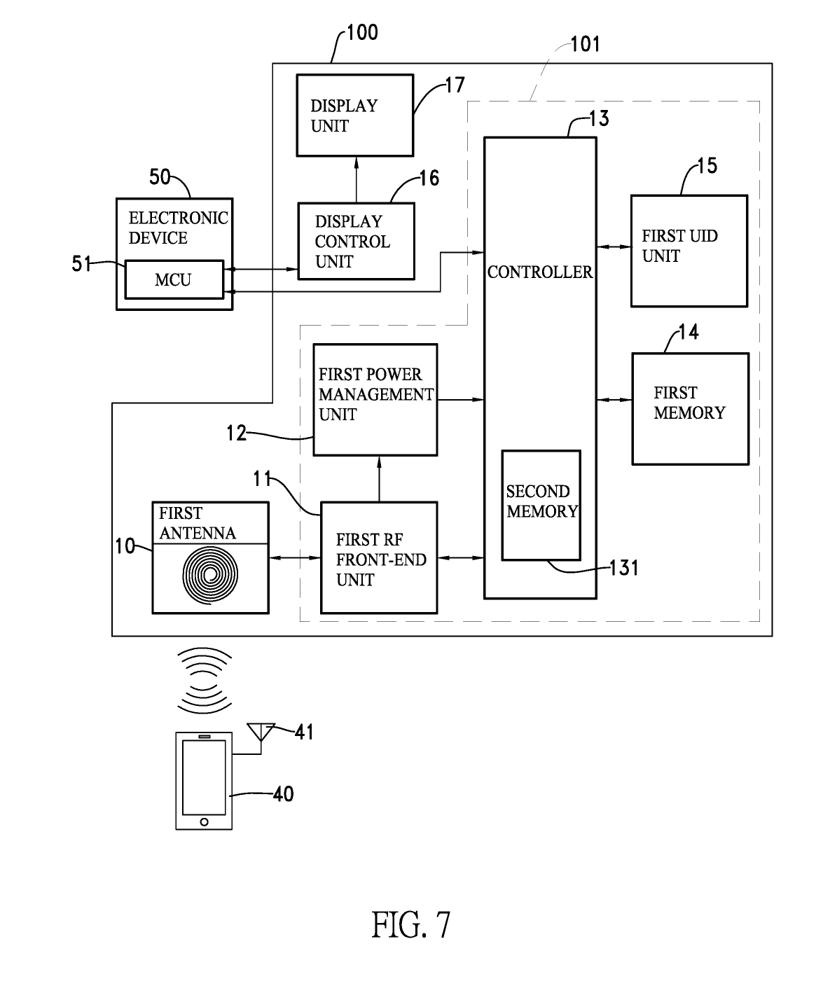

With reference to FIG. 7, a fifth embodiment of a display device with RFID functions 100 in accordance with the present invention differs from the first embodiment in that there is an additional external electronic device 50 in connection with the display device 100, and the display device 100 further includes a display control unit 16. The electronic device 50 has a microcontroller unit (MCU) 51 connected to the controller 13 of the RF processing module 101. The display control unit 16 is connected to the display unit 17 and the MCU 51 of the electronic device 50. The display unit 17 is a control circuit formed by at least one passive component, such as resistor, capacitor, MOSFET, diode or the like, or a DC-DC converter, a display control processor, a microprocessor with display control functions, or an application processor. Thus, power signals and data from the electronic device 50 can drive the display unit 17 to emit light and display data through the display control unit 16 for users to be aware of the operation status of the display device 100 or see the displayed data of the electronic device 50. Alternatively, the MCU 51 of the electronic device 50 can store the data or parameters associated with a setting of the electronic device 50 or the display unit 17 in the first memory 14 inside the RF processing module 101.

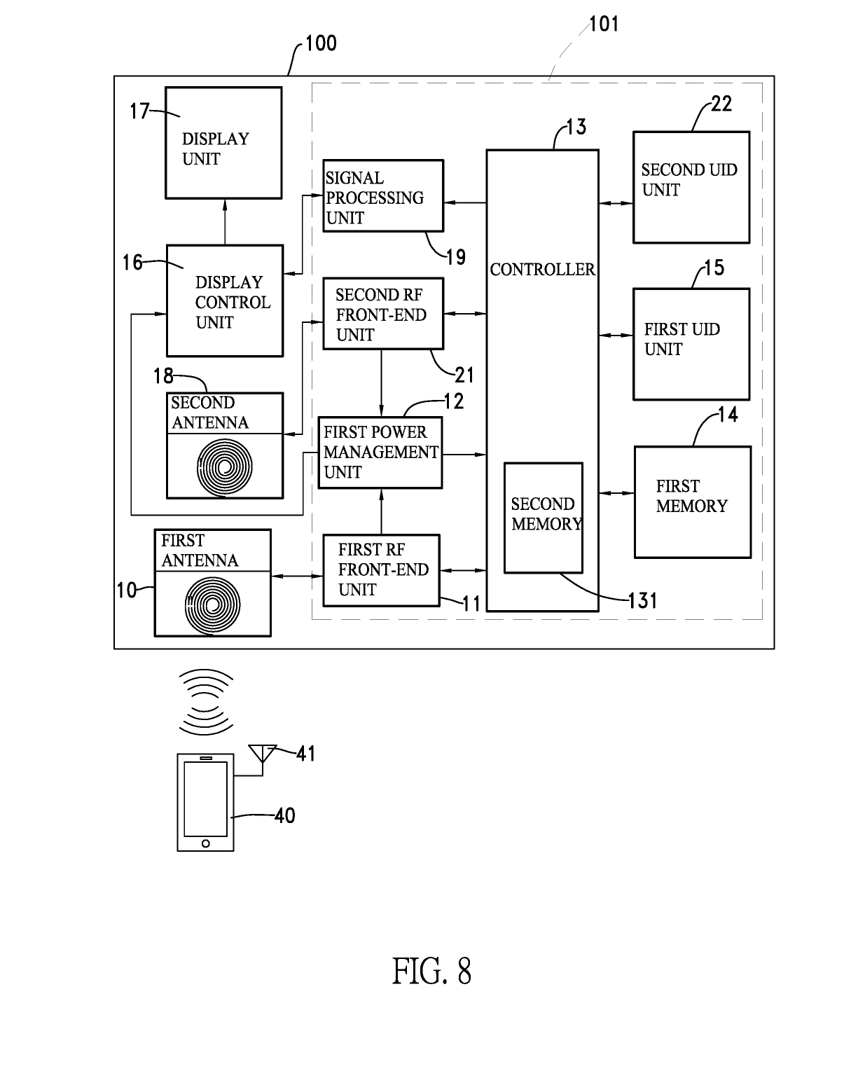

With reference to FIG. 8, a sixth embodiment of a display device with RFID functions 100 in accordance with the present invention differs from the second embodiment in that the display device 100 further includes a second antenna 18, the RF processing module 101 further includes a second RF front-end unit 21, a signal processing unit 19 and a second UID unit 22, the second RF front-end unit 21 is connected to the controller 13, the first power management unit 12 and the second antenna 18, the signal processing unit 19 is connected to the controller 13 and the display control unit 16, and the second UID unit 22 is connected to the controller 13. The signal processing unit 19 analyzes and processes the display signal and transmits a display analysis signal to the display control unit 16. The display control unit 16 drives the display unit 17 to display corresponding data. In the present embodiment, the second RF front-end unit 21 is an RFID/NFC communication unit, and the second UID unit 22 prestores another user ID for the external RFID/NFC device 40 to match or identify the user ID.

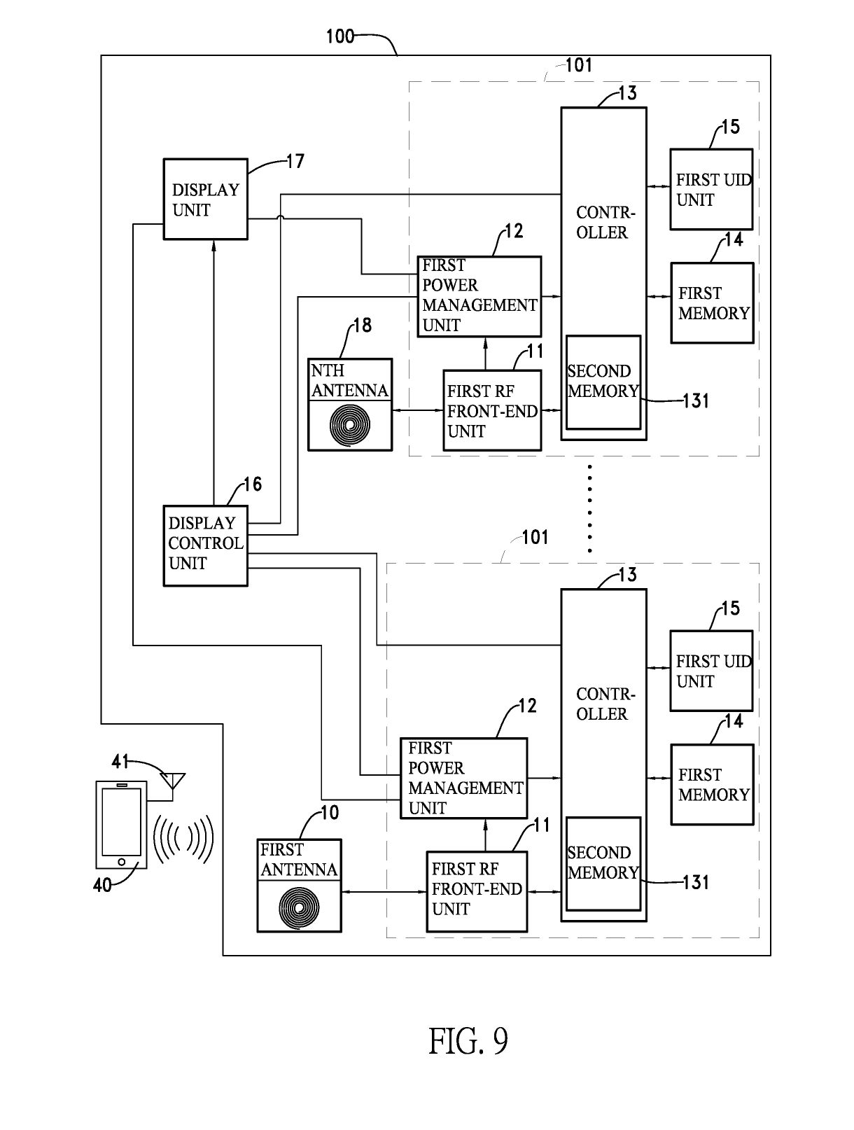

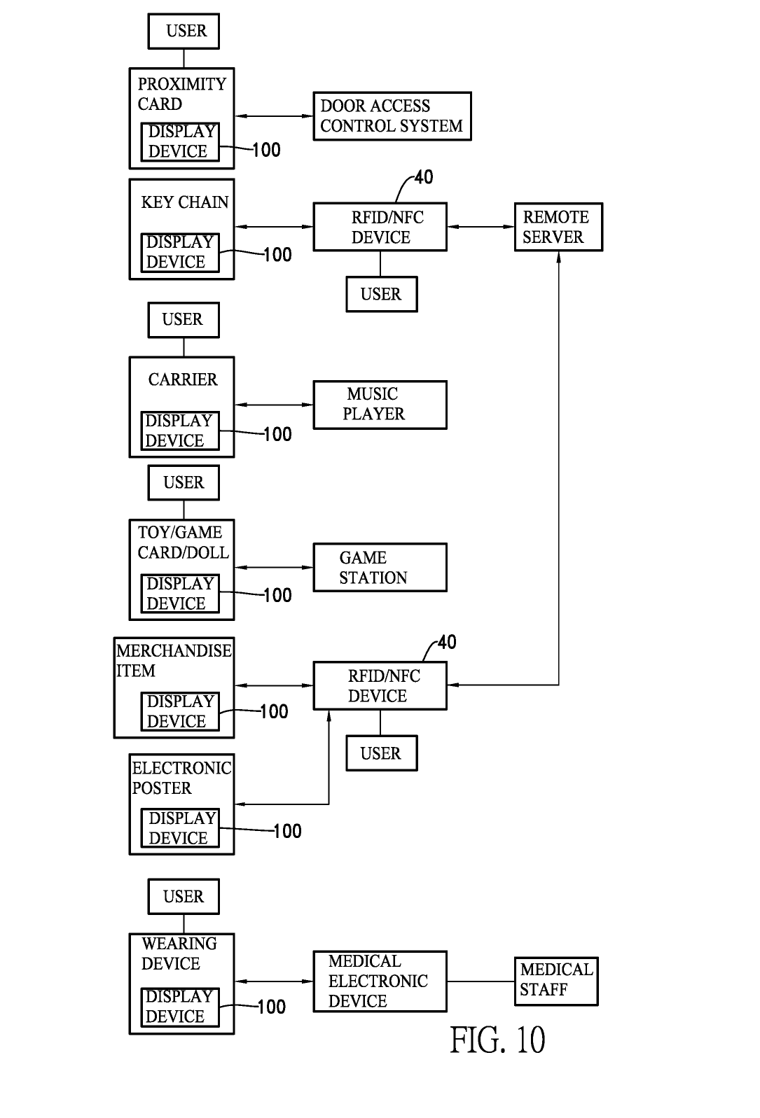

With reference to FIG. 9, a seventh embodiment of a display device with RFID functions 100 in accordance with the present invention differs from the first embodiment in that the display device 100 further includes at least one RF processing module 101 and a display control unit 16 shared by the at least one RF processing module 101. The display unit 17 is a control circuit formed by at least one passive component, such as resistor, capacitor, MOSFET, diode or the like, or a DC-DC converter, a display control processor, a microprocessor with display control functions, or an application processor. The first power management unit 12 of each one of the at least one RF processing module 101 is connected to the display control unit 16 and the display unit 17 of the RF processing module 101. One of the at least one RF processing module 101 is connected to the display control unit 16 through the controller of the RF processing module 101. The display control unit 16 is then connected to the display unit 17. The RF processing module 101 exchanges data with the RFID/NFC device 40 through the first antenna 10. In the present embodiment, there are N RF processing modules 101, the N RF processing modules 101 respectively have a first antenna 10, a second antenna (not shown), . . . , and a Nth antenna 18, and the first antenna 10 up to the Nth antenna 18 pertain to different types of antennae. Hence, the N different RF processing modules 101 can respectively collect energy through the first antenna 10, the second antenna, . . . , and the Nth antenna 18 and provide the energy to the display control unit 16 and the display unit 17 and can selectively communicate with the RFID/NFC device 40 through the first antenna 10, the second antenna, . . . , and the Nth antenna 18. With reference to FIG. 10, some applications adopting the display device with RFID functions 100 in accordance with the present invention are shown. The display device 100 can be produced in a miniaturized manner and can be embedded in various electronic products, such as electronic business card, door access card, proximity card, key chain, carrier, toy, game card, doll, merchandise, electronic poster, wearing device, smart label or the like, such that the display device 100 can display real-time states/status, interact with users' RFID/NFC devices, show advertisement and facilitate storage thereof

When the display device 100 is embedded in a proximity card, the proximity card is applied to an access control system. When users hold the proximity card to approach the access control system and successfully unlock the door, the display device 100 of the proximity card can be illuminated through the LED to increase fun, facilitate awareness of door access status for hearing-impaired persons, and affirmatively indicate that the access is allowed.

When the display device is embedded in a key chain, the key chain stores a preset website address based on NDEF format and a preset telephone number based on NDEF format, and is connected to a user's RFID/NFC device 40. When the user holds the key chain and approach the RFID/NFC device 40, the RFID/NFC device 40 can be directly connected to a website through the preset website address if the key chain stores the website address therein) or to a contact person if the key chain stores a phone number for the user to decide whether a connection should be made. The display device 100 of the key chain or the RFID/NFC device can further display indicator light or data if need.

When the display device 100 is embedded in a carrier, the carrier is connected to a music player through wireless techniques. Moreover, the music player may have a connection port being compatible with the carrier for connection, such that the connection port of the music player can engage the carrier to directly play specific music if they are matched.

When the display device 100 is embedded in a toy, a game card or a doll, the toy, the game card or the doll can be connected to a game station through wireless techniques. When users hold the toy, the game card or the doll to approach the game station, the game station generates a correspond response, such as a sound or a display, according to the UID and data of the display device 100. The game station can also transmit a corresponding signal and data to the display device for the display to be illuminated or to display.

When the display device 100 is embedded in a piece of merchandise, a user can hold the RFID/NFC device 40 to approach the piece of merchandise to identify the piece of merchandise according to the UID of the display device 100, and display related data and graphics for easy operational control. The UID and data can be also directly transmitted to a remote server for data management instead of further serial number assignment of merchandise items.

When the display device 100 is embedded in an electronic poster, a user can hold the RFID/NFC device 40 to approach the display device 100 and the electronic poster automatically generates variation in sound effect, or brightness or information.

When the display device 100 is embedded in a wearing device for the use of patients in hospitals, medical staff can get a medical electronic device close to the wearing device and then the display unit 17 of the display device 100 emits light indicative of a definite success in connection, making the wearing device ideal for a place required to be quite.

According to the foregoing applications, the display device 100 with RFID functions in accordance with the present invention can be integrated into electronic products for product identification or display of advertising information and can be inlaid or stuck on any merchandise item for users to be aware of product information or for displaying product advertisement.

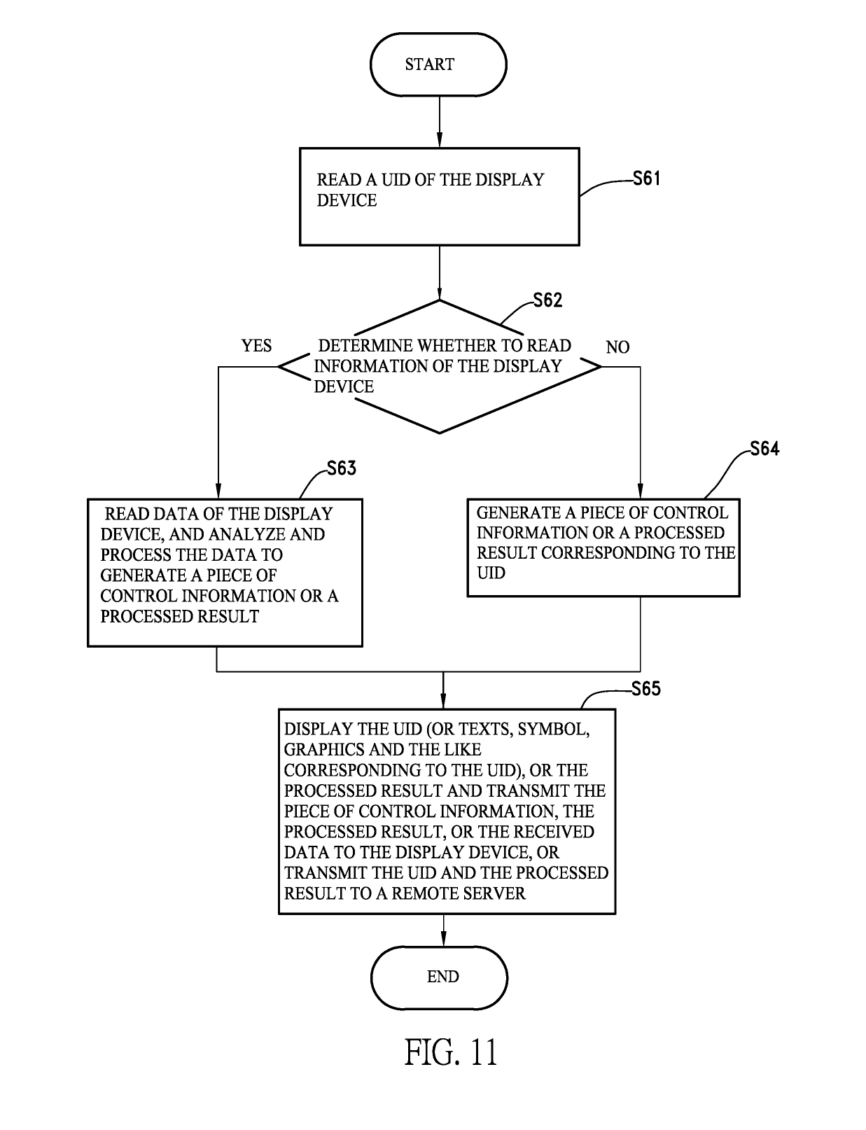

With reference to FIG. 11, a flow diagram of a data processing method for a display device with RFID functions is shown. The display device with RFID functions 100 is connected to the RFID/NFC device 40 or the electronic device 50 through a wireless technique, and the RFID/NFC device 40 or the electronic device 50 performs the following steps.

Step S61: Read a UID of the display device 100.

Step S62: Determine whether to read data of the display device according to a preset application to be applied to. In the present embodiment, the preset application corresponds to one of the applications, such as proximity card, key chain, carrier, toy, game card, doll, merchandise item, electronic poster and wearing device. If the determination result is positive, perform step S63. Otherwise, perform step S64.

Step S63: Read data of the display device 100, and analyze and process the data to generate a piece of control information or a processed result according to a need for analysis or processing of the data in the preset application.

Step S64: Generate a piece of control information or a processed result corresponding to the UID.

Step S65: Display the UID (or texts, symbol, graphics and the like corresponding to the UID) or the processed result, transmit the piece of control information, or the processed result or received data to the display device 100, or transmit the UID and the processed result to a remote server.

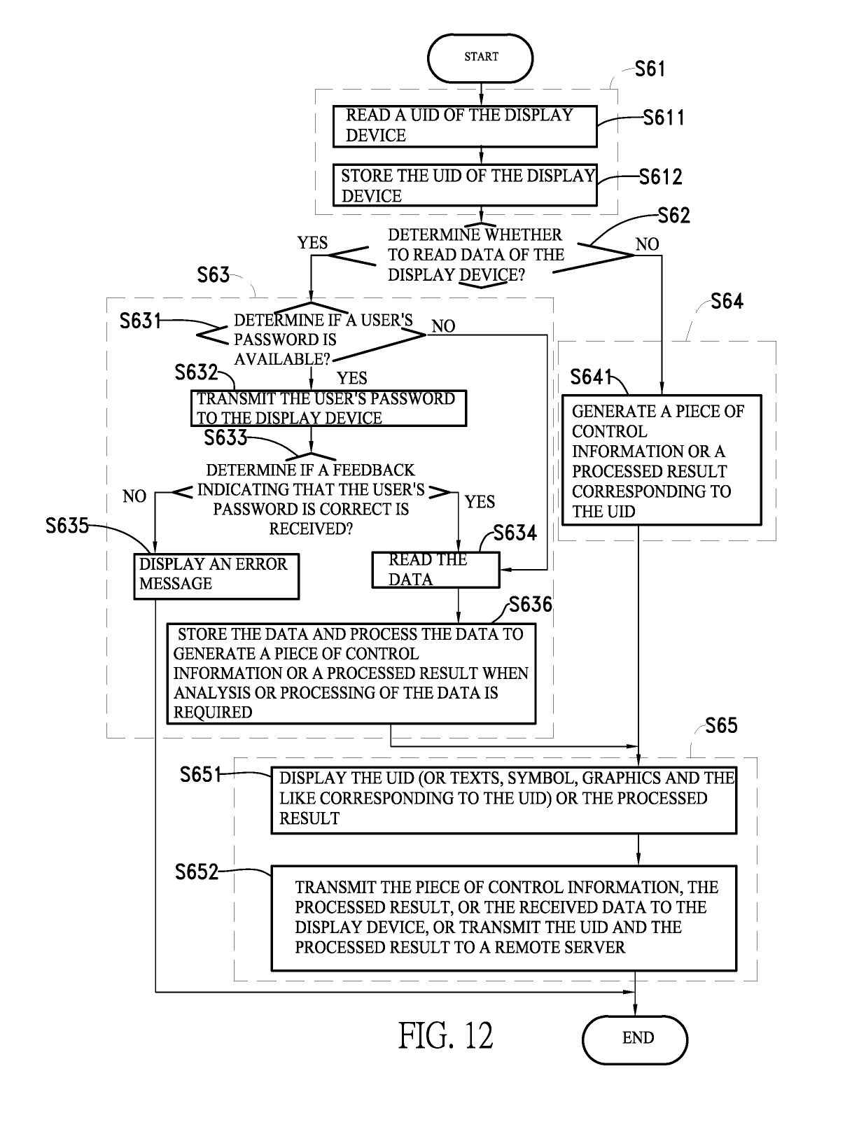

With reference to FIG. 12, a detailed flow diagram concerning the foregoing steps of the data processing method is shown.

Step S61 further includes the following steps.

Step S611: Read a UID of the display device 100. Supposing that the RFID/NFC device 40 is active, the UID of the display device will be automatically read when a connection between the RFID/NFC device 40 and the display device 100 is established.

Step S612: Store the UID of the display device 100.

Step S65 further includes the following steps.

Step S651: Display the UID (or texts, symbol, graphics and the like corresponding to the UID) or the processed result. Supposing that the received data of the display device is based on NDEF format, such as a website address, the RFID/NFC device 40 will display corresponding data (Supposing that the corresponding data is a website address based on NDEF format, a browser is connected to the website address and displays data thereon after being activated).

Step S652: Transmit the piece of control information, the processed result or the received data to the display device 100 or transmit the UID and the processed result to a remote server.

Step S63 further includes the following steps.

Step S631: Determine if a user's password is available in data read from the display device 100. If the determination result is positive, perform step S632. Otherwise, perform step S634.

Step S632: Transmit the user's password to the display device 100.

Step S633: Determine if a feedback indicating that the user's password is correct is received. If the determination result is positive, perform step S634. Otherwise, perform step S635.

Step S634: Read the data in the first memory 14 of the display device 100.

Step S635: Display an error message.

Step S636: Store the data and process the data to generate a piece of control information or a processed result according to the preset application when analysis or processing of the data is required. Supposing that the data is based on NDEF format, such as a website address, the RFID/NFC device 40 will automatically launch an application corresponding to the NDEF data (Supposing that the data is a website address based on NDEF format, a browser will be automatically activated).

According to the foregoing embodiments, in contrast to conventional techniques, the present invention has the following advantages.

1. RFID techniques for data communication and energy transmission as well as optimal circuit and elements with low power consumption are adopted in the present invention, thereby getting rid of the need of battery in many applications. Optimization in thickness allows the present invention to be applied to smart key chains or carriers with a card thickness for effectiveness of easy placement, demonstration and storage. The illuminating feature of the display unit 17 can be applied to key chains, proximity cards or smart labels in generation of an eye-catching effect for hearing-impaired persons to be aware that the label or the proximity card has been read.

2. Use UID to identify the display device to perform or control corresponding functions of the identified display device without having to further assign or record serial number of merchandise items.

3. As most operating systems (OS) can support NFC Data Exchange Format (NDEF), no additional application program needs to be installed to support applications, such as automatic reading of website address, phone number and SMS (Short message service) message, automatic link to program or automatic pairing, in RFID/NFC devices, such that the present invention is user-friendly to people irrespective of sex and age. For example, when a RFID/NFC device 40 with NFC feature and access capability to the internet approaches the display device with RFID functions 100, the display device 100 is connected to the RFID/NFC device 40 and is further automatically connected to a related web page through a NDEF website address to facilitate consumers' browsing activities.

4. Data stored in the display device 100, such as website address, date, serial number and the like) can be read and analyzed to generate highly readable data or charts through the display device or the electronic device 50 for the ease of management, diagnosis, analysis, tracking and maintenance. The UID and data of the display device can be sent to a remote server through various wired or wireless network devices for data exchange or storage, service management and authentication that can be displayed on the display unit 17 on a real-time basis. The present invention is optimally integrated and designed to fulfill the goal of easy storage and better operational convenience.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A data processing method for a display device with radio frequency identification (RFID) functions, wherein the display device with RFID functions is connected to a near-field communication (NFC) device or an electronic device through RFID techniques, the data processing method performed by the RFID/NFC device or the electronic device and comprising steps of:
Reading a user identification (UID) of the display device;
determining whether to read data of the display device;
reading the data in the display device and processing the data to generate a piece of control information or a processed result according to a preset application to be applied to, when determining to read the data of the display device; and
displaying the UID, the data corresponding to the UID, or a processed result, transmitting the piece of control information, the processed result and the received data to the display device, or transmitting the UID and the processed result to a remote server.

2. The data processing method as claimed in claim 1, further comprising a step of generating a piece of control information or a processed result corresponding to the UID when determining not to read the data of the display device.

3. The data processing method as claimed in claim 1, wherein
the step of reading the UID of the display device further comprises steps of:
reading the UID of the display device; and
storing the UID of the display device.
the step of displaying the UID, the data corresponding to the UID, or a processed result further comprises steps of:
displaying the UID or texts or symbol or graphics corresponding to the UID or the processed result; and
transmitting the piece of control information, the processed result, or the received data to the display device or transmitting the UID and the processed result to a remote server.

4. The data processing method as claimed in claim 1, wherein the step of reading the data in the display device, and analyzing and processing the data further comprises steps of:
determining if a user's password is available in data read from the display device;
transmitting the user's password to the display device when determining that the user's password is available;
determining if a feedback indicating that the user's password is correct is received;
reading the data in the display device when the feedback indicating that the user's password is correct is received;
displaying an error message when the feedback indicating that the user's password is not correct is received; and
storing the data and processing the data to generate a piece of control information or a processed result according to the preset application.

5. A display device with radio frequency identification (RFID) functions, comprising:
a display unit;
a first antenna transceiving signals and generating a first induction current by way of electromagnetic induction; and
a radio frequency (RF) processing module connected to the first antenna, receiving signals and the first induction current from the first antenna, and having:
a first memory storing data; and
a first UID unit storing at least one user ID (UID) adapted for an external RFID/NFC device to identify the at least one UID, process and analyze the UID and the data received from the RF processing module to generate control data, and then transmit the control data, the UID and the data back to the RF processing module through the first antenna or to a remote server.

6. The display device as claimed in claim 5, wherein the RF processing module further comprises:
a first power management unit connected to the display unit;
a first RF front-end unit connected to the first antenna and the first power management unit; and
a controller having a second memory to store a setting of the RF processing module, and connected to the first RF front-end unit, the first power management unit and the first memory and the first UID unit.

7. The display device as claimed in claim 5, wherein the RF processing module further comprises:
a first power management unit connected to the display unit;
a first RF front-end unit connected to the first antenna and the first power management unit; and
a controller having a second memory to store a setting of the RF processing module, and connected to the first RF front-end unit, the first power management unit and the first memory and the first UID unit;
the display device further comprises a display control unit connected to the first power management unit and the display unit to instruct the display unit to display.

8. The display device as claimed in claim 7, wherein the controller of the RF processing module is further connected to the display control unit and receives signals transmitted from the RFID/NFC device through the first antenna, the display control unit receives a display signal or a control signal transmitted from the controller and transmits the display signal to the display unit to instruct the display unit to emit light, display data, and store the data or parameters associated with a setting of the display unit in the first memory inside the RF processing module.

9. The display device as claimed in claim 5, further comprising:
a second antenna; and
a display control unit connected to the second antenna and the display unit, wherein the second antenna generates a second induction current used to enable the display unit to emit light and display data directly through the display control unit;
the RF processing module further comprises:
a first power management unit;
a first RF front-end unit connected to the first antenna and the first power management unit; and
a controller having a second memory to store a setting of the RF processing module, and connected to the first RF front-end unit, the first power management unit, the first memory and the first UID unit.

10. The display device as claimed in claim 9, wherein the controller is further connected to the display control unit, and the display control unit receives a display signal or a control signal transmitted from the controller and transmits the display signal to the display unit to instruct the display unit to emit light, display data, and store the data or parameters associated with a setting of the display unit in the first memory inside the RF processing module.

11. The display device as claimed in claim 5, further comprising:
a second power management unit connected to the display unit for the display unit to receive energy transmitted from the second power management unit;
a display control unit connected to the second power management unit, the display unit and the controller to instruct the display unit to display;
wherein the RF processing module further comprises:
a first power management unit;
a first RF front-end unit connected to the first antenna and the first power management unit; and
a controller having a second memory to store a setting of the RF processing module, and connected to the first RF front-end unit, the first power management unit, the first memory and the first UID unit.

12. The display device as claimed in claim 5, further comprising:
an electronic device having a microcontroller unit (MCU) connected to the controller of the RF processing module; and
a display control unit connected to the display unit and the MCU of the electronic device driving the display unit to emit light and display data through the display control unit with power signals and data transmitted from the electronic device for the display unit to display operation status thereof or data displayed on the electronic device;
wherein the RF processing module further comprises:
a first power management unit;
a first RF front-end unit connected to the first antenna and the first power management unit; and
a controller having a second memory to store a setting of the RF processing module, and connected to the first RF front-end unit, the first power management unit, the first memory and the first UID unit.

13. The display device as claimed in claim 6, further comprising a second antenna;
wherein the RF processing module further comprises:
a second RF front-end unit connected to the controller, the first power management unit and the second antenna ;
a signal processing unit connected to the controller and the display control unit; and
a second UID unit connected to the controller.

14. The display device as claimed in claim 5, further comprising:
at least one RF processing module, wherein the first power management unit of each one of the at least one RF processing module is connected to the display control unit and the display unit of the RF processing module, one of the at least one RF processing module is connected to the display control unit through the controller of the RF processing module, and each one of the at least one RF processing module exchanges data with the RFID/NFC device through the first antenna thereof; and
a display control unit shared by the at least one RF processing module and connected to the display unit.
